(19) United States
(12) Patent Application Publication
(10) Pub. No.: US 2009/0119699 A1
(43) Pub. Date: May 7, 2009

(54) SYSTEM FOR ACCESSING A TELEVISION OVER IP SERVICE IN AN IMS ARCHITECTURE NETWORK

(75) Inventors: Magali Crassous, Bouc Bel Air (FR); Mikhael Said, Paris (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/300,670

(22) PCT Filed: Jun. 1, 2007
(86) PCT No.: PCT/FR07/51366

§ 371 Date: Nov. 13, 2008

(30) Foreign Application Priority Data
Jun. 8, 2006 (FR) 0652066

(51) Int. Cl. H04N 7/16

(52) U.S. Cl. 725/25

(57) ABSTRACT

The invention relates to a system for activating a television over IP (IPTV) service in an IMS architecture network (2) from a terminal (10) of a user subscribing to a television channel provided by said service. According to the invention, the system includes, in the IMS architecture network (2), an IPTV server (23) containing subscription information associating the user with the channel and information about the reception capacity required for the channel, and the terminal (10) includes means for sending the server (23) a message requesting activation of the television service and containing reception capacity information provided by the terminal (10). The server (23) can check the compatibility between the reception capacity information received from the terminal (10) and the reception capacity information required for the channel, and if compatibility is confirmed, send the terminal (10) a message in response to the activation request message, said response message containing an IP address of the channel. The invention can be applied to IP networks enabling audiovisual data to be broadcast in the IMS.

The present invention relates to a technique for activating a service in an IP (Internet Protocol) network having an IMS (IP Multimedia Subsystem) architecture from a terminal of a user logged onto the network.

The invention finds particularly advantageous applications in IP networks for broadcasting audiovisual data in the IP multimedia subsystem defined by the 3GPP (3^{rd} Generation Partnership Project) and TISPAN (Telecommunications and Internet converged Services and Protocols for Advanced Networking) standardization organizations.

The IMS network architecture was introduced by the 3GPP for mobile networks and then adopted by TISPAN for fixed networks. It provides dynamic setup and monitoring of multimedia sessions between two clients and reservation of resources at the media stream transport network level. It also manages interaction of services.

At present the IMS provides access only to telephone, videophone, presence, and instant messaging services.

The television over Internet Protocol (IPTV) service enables television channels to be received in an IP network. Providing the IPTV service requires the terminal to obtain the addresses of the channels to which the user subscribes.

Current solutions for providing this service are usually proprietary solutions. These solutions enable the user terminal to recover a list of the IP addresses of the authorized channels, referred to as the “service plan”, via an IPTV-dedicated platform in fixed or mobile networks. This list can be recovered using the HTTP (HyperText Transfer Protocol), the service plan being included in the data conveyed by that protocol. In contrast, reservation of resources associated with the list of channels is not defined; it is often static, with no flexibility.

A drawback of the IMS architecture is that it does not offer implementation of the IPTV service in fixed or mobile networks. The mechanisms provided in the IMS, although defining generic procedures for multimedia services, do not define how to integrate the IPTV service. In particular, in the current version of the standard there is no provision for recovering the service plan, i.e. the channels to which the user subscribes and the corresponding IP addresses.

There is therefore a need for a technique enabling an IPTV service to be integrated into an IMS architecture for fixed or mobile IP networks and defining a system enabling the service plan associated with the user to be recovered.

The invention addresses this need by proposing a system for accessing a service in an IP network having an IMS architecture from a user terminal logged onto said network.

According to the invention, said service is a television over IP service, said user subscribing to a list of at least one television channel of said service, and said system includes an application server including means activated on reception of a service access request sent by said terminal for:
determining information about said user's subscription to said list and information about the reception capacity necessary for said at least one channel;
verifying the compatibility of said information about the reception capacity necessary for said at least one channel and a reception capacity offered by said terminal;
selecting at least one channel from said list as a function of said compatibility verification; and
sending said user terminal a response to said request, the response containing information about reception of said at least one selected channel.

Thus the IMS architecture enables integration of the IPTV service when registering the terminal in the IMS. By means of the invention, the IPTV service can therefore enjoy the advantages of the IMS, namely fixed/mobile integration, mutualization, and generic mechanisms for services, interaction of services, reservation of network resources, mutualized billing, etc., which was not possible in the techniques used for the IPTV service in the prior art. Moreover, implementing an audiovisual service greatly enriches the IMS service offer.

An advantage of the invention is that it proposes a new procedure in the framework of an IMS architecture enabling recovery of a service plan associated with a user so that it becomes possible to integrate an IPTV service into an IMS architecture.

This procedure relies in particular on verification of the rights of the user by the IPTV application server in a database associated with the service and on selection by that server of one or more channels from the list of channels to which the user subscribes. This selection relies on verifying beforehand that the reception capacities offered by the terminal are compatible with the reception capacities required for any particular television channel.

The invention also uses procedures linked to a signaling protocol, for example of the SIP (Session Initiation Protocol) type, for the service access request and for recovery by the terminal of information about the channels to which the user subscribes that have been adopted by the IPTV application server, in particular the names and addresses of the TV channels in the IP transport network. To this end, on reception of an SIP access request message, the IPTV application server inserts reception information into the list of subscribed channels in SDP (Session Description Protocol) parameters of the SIP response message and sends that information to the user terminal with the response message.

The service access request sent by the terminal can be a request for initial activation of the service (for example on switching on an audiovisual terminal) or a request to change service (for example if the terminal is seeking to modify certain of the parameters of the service to which it already has access, such as the channel viewed, for example).

Such requests can therefore contain parameters relating to the service requested by the terminal, for example an identifier of a channel that it is seeking to view or a required level of service.

According to one advantageous feature of one embodiment, the system of the invention also includes means for reserving resources of a transport network necessary for said terminal to receive said at least one selected channel.

Such reservation of resources, for which there is no provision in prior art Television over Internet Protocol systems, is particularly beneficial in that it enables good reception by the user terminal of the stream associated with the television channel to be viewed. In a transport network having abundant resources, such reservation is not strictly necessary, however.

These resource reservation means can be implemented in a proxy server of the IMS architecture network and are triggered when the proxy server receives a response from the IPTV application server to a service access request from a terminal.

In the final analysis, the system of the invention therefore enables the IPTV service to enjoy the many advantages of an IMS architecture network, in particular:
mechanisms inherent to the IMS for reserving resources in the IP transport network necessary for receiving a TV channel;
mechanisms defined in the IMS entities with regard to interaction between IMS services;
charging mechanisms defined in the IMS; and
so that the IMS service offer can be enriched by the provision of an audiovisual service.

According to one advantageous feature of the invention, said reception capacity offered by said terminal is determined on the basis of:
reception capacity information contained in said service access request; and/or
the type of said terminal.

This type, which can be indicated in the INVITE message sent by the terminal in order to access the service, for example, constitutes a good indication of the reception capacities offered by the terminal and can therefore be used by the IPTV application server to select the television channel(s) that the terminal is authorized to view.

The reception capacity information contained in the service access request can correspond to capacity information linked to the parameters for connection of the terminal to the network (for example the maximum bit rate to which the user is entitled as a function of their subscription) or information as to the level of service required by the terminal (for example whether the terminal requires to receive a television channel in standard definition (SD) or in high definition (HD)).

Said reception information advantageously belongs to the group including:
an identifier of said selected channel;
an address of said selected channel;
a reception capacity required for said selected channel, or more generally network characteristics of the channel, for example the required bit rate; and
information representing a content of said selected channel, which could be used in the context of parental control, for example.

According to another aspect of the invention, said IMS architecture network includes a routing server having access to information associating said user terminal with one of said application servers and including means for routing said service access request to said application server associated with said terminal.

In this embodiment, during registration and authentication of the terminal with the IMS, the routing server known in the IMS as the S-CSCF (Serving-Call Session Control Function) server recovers the IFC (Initial Filter Criteria) detection point associated with the IPTV service from a database containing the profile of the user in terms of detection points of the set of services to which the user subscribes. The database containing the user profile is either a UPSF (User Profile Server Function) database as defined by TISPAN or an HSS (Home Subscriber Server) database as defined by the 3GPP.

On reception of an IPTV service access request, the S-CSCF server, having identified the user in the message, recovers from the user database the associated detection points and in particular that corresponding to the IPTV application server. It therefore identifies the IPTV application server routing to which of the access request sent by the terminal it must trigger.

In a different embodiment of the invention, the service access request sent by the terminal contains an address of the IPTV application server, i.e. a routing identifier of the television server in the IMS architecture network.

That identifier can be an SIP Uniform Resource Identifier (URI).

The message requesting activation of the IPTV service is then routed directly to the IPTV application server via the S-CSCF server, which then serves merely as a router.

According to another advantageous feature of the invention, said user terminal includes means for processing said reception information for said selected channel and means for receiving a stream corresponding to said channel. For example, the terminal extracts from the reception information the IP address of the television channel that it is seeking to view and uses that IP address to obtain the stream associated with that channel from the TV source via the transport network.

In one advantageous embodiment of the invention, said application server also includes means for determining a session identifier contained in said access request sent by said terminal and means for verifying whether said session identifier corresponds to a session already in progress with said terminal.

If the IPTV application server detects that a session with the terminal is already in progress, because the session identifier is unchanged relative to the preceding request received from the same terminal, it deduces that the request received is not a service initialization request but rather a change of service request. It then maintains the current session and, to respond to the new request from the user terminal, activates its means for sending a response to the terminal in order to insert into its response message the reception information that has changed as compared to its preceding response message.

The invention also relates to an application server of a system for accessing a service in an IP network having an IMS architecture from a user terminal logged onto said network. According to the invention, said server is an IPTV server and includes means activated on reception of a service access request sent by said terminal for:
determining information about said user's subscription to said list and information about the reception capacity necessary for said at least one channel;
verifying the compatibility of said information about the reception capacity necessary for said at least one channel and a reception capacity offered by said terminal;
selecting at least one channel from said list as a function of said compatibility verification; and
sending said user terminal a response to said request containing at least information about reception of said at least one selected channel.

The invention further relates to a terminal for accessing a service in an IP network having an IMS architecture, which terminal includes:
means for sending an IPTV service access request to a television over IP application server of said IMS architecture network, a user of said terminal subscribing to a list of at least one television channel of said service, and said access request including information about the reception capacity offered by said terminal;
means for processing a response to said request sent by said application server and containing information about reception of a channel selected in said list by said application server; and
means for receiving a stream corresponding to said selected channel.

The invention further relates to a method of accessing a service in an IP network having an IMS architecture from a user terminal logged onto said network. According to the invention, said service is an IPTV service, said user subscribing to a list of at least one television channel of said service, and said method includes:
a step of receiving a service access request sent by said terminal;
a step of determining information about said user's subscription to said list and information about the capacity necessary to receive at least one said channel;
a step of verifying the compatibility of said information about the reception capacity necessary for said at least one channel and a reception capacity offered by said terminal;
a step of selecting at least one channel from said list as a function of said compatibility verification; and
a step of sending said user terminal a response to said request containing information about reception of said at least one selected channel.

The invention relates finally to a computer program including program code instructions for executing the steps of the above method of accessing a service.

The following description with reference to the appended drawings, which are provided by way of non-limiting example, explains clearly in what the invention consists and how it can be reduced to practice.

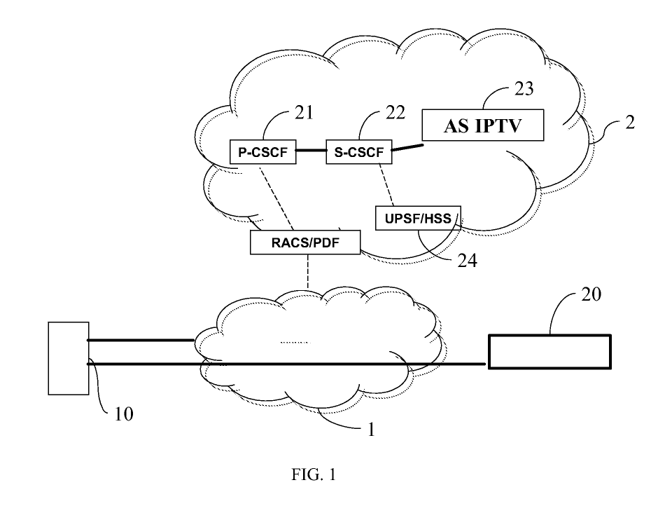

FIG. 1 is a diagram representing a network architecture of the invention for activating an IPTV service.

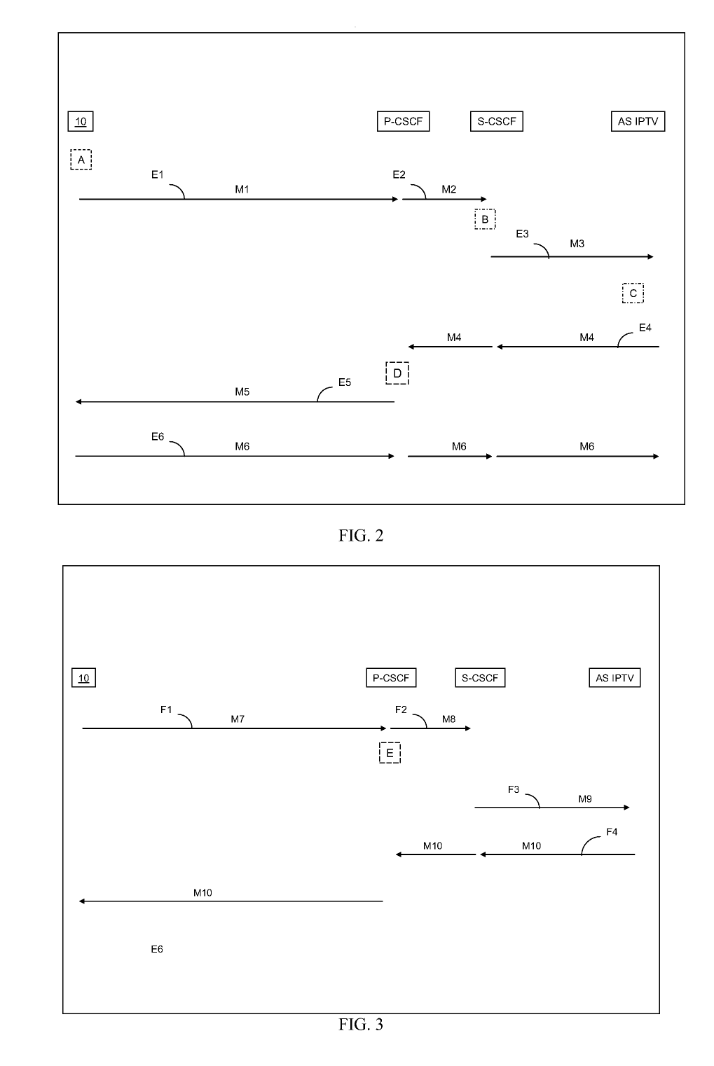

FIG. 2 is a diagram showing a television service activation phase.

FIG. 3 is a diagram showing a television service interruption phase.

FIG. 1 shows a system for activating an IPTV service on an IP transport network 1 via which a terminal 10 can receive media streams provided by a TV source 20 when a user of the terminal 10 has subscribed beforehand to one or more television channels provided by an operator or an associated third-party provider.

The terminal 10 is a fixed or mobile terminal and includes means for reproducing an audiovisual content and SIP signaling means. In the context of the invention, the terminal 10 can be a prior art audiovisual terminal (such as a television) plus an SIP client, for example, which two elements can be physically separate or integrated into the same unit. Thus the terminal 10 can be a mobile telephone with a screen or integrate a set top box and a display screen, etc.

As shown in FIG. 1, the IPTV service is activated from the terminal 10 in an IMS architecture network 2 that includes:
a P-CSCF (Proxy-Call Server Control Function) proxy server 21 that is the first point of contact with the terminal 10 of the user subscriber in the IMS network and manages interaction with the resources of the IP transport network 1;
an S-CSCF routing server 22 that manages the subscriber in the IMS network and in particular trigger points (also known as detection points or IFC) to servers to which the user subscribes; the S-CSCF server 22 is assigned to the user by an I-CSCF (Interrogating CSCF) server, not shown, during registration of terminal 10 with the IMS network;
a television over IP application server (IPTV AS) 23, which is a new element of an IMS architecture of the invention compared to a prior art IMS architecture; it is an SIP server for allocating the user one or more channels from those to which they subscribe, following a request by the user to activate the service, in accordance with a procedure described in detail below; the IPTV application server 23 contains information relating to the user's subscription supplied by the operator of the service or an associated third-party provider, such as the channels subscribed to, and information relating to the transport network 1, such as the reception capacities and the IP address of each channel; and
a UPSF or HSS database 24 containing the profile of the user in terms of the services subscribed to and, here in particular, the IPTV service defined by the television channels to which the user wishes to subscribe; this database 24 is also fed with data by the service operator or an associated third-party provider after the user has taken out a subscription via a webpage or by telephone; it contains detection points associated with the user, in particular that of the IPTV application server 23; the S-CSCF and I-CSCF SIP proxies interrogate the database 24 during registration of the user terminal.

In the IMS architecture network 2 described above, pairs or all three of the P-CSCF, S-CSCF, and I-CSCF SIP proxy servers can be combined in the same equipment.

When, after subscribing to the IPTV service, the user wishes to activate it, an IMS network registration phase precedes the activation or access phase as such.

The registration phase is effected automatically or by the terminal 10 sending a registration message, for example an SIP Register message, including in particular an identifier of the subscriber in the IMS network 2. The Register message reaches the P-CSCF proxy server 21, which forwards it to an I-CSCF server, not shown, which assigns an S-CSCF server 22 to the terminal 10.

In a first embodiment, the S-CSCF server 22 recovers from the UPSF or HSS user database 24 the associated detection points, including the detection point of the IPTV application server 23 for activating the IPTV service.

In another embodiment, the operator can choose to include the routing identifier SIP URI of the IPTV application server 23 in the SIP Invite service access request message, described below. In relation to the IPTV service, the S-CSCF server 22 behaves merely as a router for routing the Invite message to the IPTV application server 23.

Registered with the IMS network 2 in this way, the terminal 10 can access the IPTV service using a service activation procedure described below with reference to FIG. 2.

After registration with the IMS network 2, the user is in a registered state A and triggers activation of the IPTV service from the terminal 10, for example by switching on their fixed television or activating the TV application on their mobile telephone.

The fixed or mobile terminal sends the P-CSCF server 21 an SIP Invite message M1 requesting access to the IPTV service in the step E1. This message contains SDP data relating in particular to the information offered by the terminal on its capacity to receive channels, for example the codecs supported, and a description of the control protocol enabling selection of a channel on the terminal (“zapping”), for example the IGMP (Internet Group Management Protocol).

The P-CSCF server 21 sends the Invite message M2 to the S-CSCF server 22 managing the user in the step E2.

During registration, a detection point or IFC (Initial Filter Criterion) was set in the S-CSCF server 22 on reception of the Register message relating to the IPTV service. The S-CSCF server 22 recognizes (B) this detection point and sends the Invite message to the IPTV application server 23. Of course, as indicated above, this is not obligatory if the destination URI relating to the IPTV application server 23 is indicated directly in the Invite message.

On reception of the message, the S-CSCF server 22 sends the activation request M3 to the IPTV application server 23 (step E3).

When it receives the Invite message, the IPTV application server 23 verifies the rights of the subscriber in a database associated with the service and extracts one or more channels from the list of channels subscribed to. This list of channels, also known as the service plan, is determined (C) by verifying the compatibility of the information about the capacity required to receive each channel and the information about the reception capacity of the terminal, which can come from the capacities indicated in the SDP, for example, or from the terminal type indicated in the Invite message. This list can overlap the entire list of channels subscribed to. The list of channels chosen includes, for each channel:
a channel identifier, for example its name;
a channel IP address; and
where appropriate characteristics of the channel in the transport network 1, such as the required bit rate.

The response M4 sent by the IPTV application server 23 (step E4) contains the list of chosen channels, inserted into SDP parameters. This response can be an SIP 200 OK message in the event of success, another SIP message triggering other intermediate negotiation exchanges or a failure message.

The IP addresses of the channels specified by the application server can be:
multicast group addresses; and
unicast addresses.

The list of channels is conveyed in the SDP parameters. Depending on the transport protocol used, for example MPEG2-TS or RTP (Real Time Protocol), a particular channel can be described in one or more SDP media parameters. The media description must include an identifier of the channel, enabling the terminal 10 to find out to which streams the channel corresponds. This identifier also enables correlation of the media relating to the same channel. For example, it can contain the name of the channel and the bundle in which it is broadcast. The SDP media title parameter i can be used to designate the channel. The media must also include the IP address of the channel, for example in the field c (connection information). This IP address enables the terminal 10 to receive the channel requested by means of the selection (zapping) protocol. For IPTV over fixed ADSL access, for example, if the channels are broadcast in multicast mode, this address is the multicast address to which the channel is broadcast.

On reception of the SIP response message, the P-CSCF server 21 activates reservation (D) of the resources of the transport network 1 necessary for broadcasting the selected channels and can also install policies that bar the user selecting the channels that have not been chosen on the terminal 10.

Resource reservation complies with the 3GPP and TISPAN specifications. A number of TV channels can be present in the SDP parameters in the form of media parameters. The various channels present in the SDP must be capable of being the subject of a single resource reservation. It is not necessary to reserve resources separately for all the channels, given that only one channel can be viewed at a time. The IPTV application server 23 can specify this in SDP using the method indicated in RFC 3388 (media grouping) and RFC 3524 (reservation of resources for each media stream).

For mobile telephones, as defined by the 3GPP, the P-CSCF server 21 reserves resources vis-à-vis the PDF (Policy Decision Function). If necessary, the terminal is then responsible for establishing one or more PDP (Packet Datagram Protocol) contexts for transporting the channel selection (zapping) protocol and the selected TV channel.

For fixed terminals, as defined by the TISPAN group, the P-CSCF server 21 establishes a request for resources to a resource and admission control subsystem (RACS) responsible for establishing resources and rules for the transport network 1.

The P-CSCF server 21 sends the response M5 to the terminal 10 (step E5). The latter terminal then has a list of permitted channels and their associated address(es). The terminal can initiate one or more particular channels corresponding to the requirement for resources for receiving channels and for conveying channel selection (zapping) commands, especially for mobile networks.

Finally, by means of a message M6, the terminal 10 acknowledges the response from the IPTV application server 23 (step E6).

If the user changes channel on the terminal 10, by whatever method, that change of channel can be signaled by sending an SIP message, for example the Publish message, which is relayed to the IPTV application server 23, and is used in particular for carrying out audience surveys. This SIP message can be sent on each change of channel or following a change of channel and a time-delay, for example if the user remains on the selected channel for more than 10 seconds. This mechanism enables the re-use of existing elements or elements defined in IMS architectures for presence management.

The channel selection (zapping) protocol for controlling received TV streams can be the IGMP, for example, for channels broadcast by multicast streams. The SDP parameters of the response message then contain the corresponding multicast group address for each channel. The group address returned by the IPTV application server 23 for the same channel can differ according to the capacities of the terminal 10 and its type.

This protocol for selecting channels from the terminal 10 can also be the RTSP (Real Time Streaming Protocol).

A change of IPTV service level having consequences for the transport network 1 can make use of the SIP mechanisms described for the service activation phase. It is triggered in the terminal 10 if the user wishes to access an IPTV service different from that they initially activated (for example in the event of changing the channel that the user wishes to view or the definition level of that channel). The terminal then initiates the procedure described above, but for the same IMS session, i.e. with the same session identifier as the current session, the consequence of which is to change the resource reservation, if necessary.

One particularly pertinent use is changing the definition level of the channels: changing from SD (Standard Definition) to HD (High Definition). Resource reservation then differs from one set of channels to another.

To be more precise, the terminal sends the IPTV application server 23 an access request containing the IMS session identifier of the current session and the required definition level and/or the identifier of the channel requested. The IPTV application server 23 then detects that the IMS session identifier has not changed and corresponds to a session that is already open. It therefore responds to the request from the terminal 10 without changing the IMS session, simply by sending it in an SDP message the reception information(s) that has to be modified relative to the current session.

Thus if the user of the terminal 10 uses a channel with the identifier CH1, broadcast in SD mode, and wishes to “zap” to another channel with the identifier CH2, broadcast only in HD mode, the terminal 10 sends a request to the IPTV application server 23 containing the identifier of the current IMS session and the identifier CH2 of the channel that they wish to view. The IPTV application server 23 detects that the IMS session identifier has not changed and that the current session must therefore continue. It verifies the compatibility of the reception capacity of the terminal 10 and the reception capacity required to receive the channel CH2, which is broadcast in HD mode (for example, it verifies that the terminal is capable of receiving an HD stream and is not limited to receiving SD streams, for example). If compatibility is verified, it activates its means for sending a response message to the terminal 10, into which message it inserts reception information relating to the channel CH2 that the terminal 10 needs, for example the IP address of the channel CH2.

Terminating the IPTV service corresponds to sending the SIP message Bye, which triggers the release of resources in the transport network 1. The kinematics of SIP exchanges during a service termination phase are shown in FIG. 3.

The user of the terminal 10 has decided to exit the IPTV service, switching the television to standby or shutting down the TV application on the mobile telephone, for example. It sends a Bye message M7 to the P-CSCF server 21 (step F1). For a mobile telephone, the terminal 10 can initiate one or more PDP context deactivations.

The P-CSCF server 21 frees the resources of the transport network 1 allocated to the IPTV service (E).

The P-CSCF server 21 sends the Bye message M8 to the S-CSCF server 22 (step F2).

The S-CSCF server 22 sends the Bye message M9 to the IPTV application server 23 that responds to an SIP message.

The SIP response message M10 is sent (step F4) to the terminal 10 via the S-CSCF server 22 and the P-CSCF server 21.

The invention also provides a computer program containing program code instructions for executing the steps of the service access method described above.

The program or software module code instructions can be stored in or transmitted by a data medium, which can be a material storage medium, for example a CD-ROM, a magnetic diskette or a hard disk, or a transmissible medium, such as an electrical, optical or radio signal, or a telecommunications network transmission medium.

1. A system for accessing a service in an IP network having an IMS architecture from a user terminal of said network;
characterized in that said service is a television over IP service, said user subscribing to a list of at least one television channel of said service; and in that
said system includes an application server including means activated on reception of a service access request sent by said terminal for:
determining information about said user's subscription to said list and information about the reception capacity necessary for said at least one channel;
verifying the compatibility of said information about the reception capacity necessary for said at least one channel and a reception capacity offered by said terminal;
selecting at least one channel from said list as a function of said compatibility verification; and
sending said user terminal a response to said request, the response containing at least information about reception of said selected at least one channel.

2. A system according to claim 1, characterized in that it also includes means for reserving resources of a transport network necessary for said terminal to receive said selected at least one channel.

3. A system according to claim 1, characterized in that said reception capacity offered by said terminal is determined on the basis of:
reception capacity information contained in said service access request; and/or
the type of said terminal.

4. A system according to claim 1 about reception of said selected channel, characterized in that said information belongs to the group including:
an identifier of said selected channel;
an address of said selected channel;
a reception capacity required for said selected channel; and
information representing a content of said selected channel.

5. A system according to claim 1, characterized in that said network includes a routing server having access to information associating said user terminal with one of said application servers and including means for routing said service access request to said application server associated with said terminal.

6. A system according to claim 1, characterized in that said service access request sent by said terminal contains an address of said application server.

7. A system according to claim 1, characterized in that said user terminal includes means for processing said information about reception of said at least one selected channel and means for receiving a stream corresponding to said channel.

8. A system according to claim 1, characterized in that said application server also includes means for determining a session identifier contained in said access request sent by said terminal and means for verifying whether said session identifier corresponds to a session already in progress with said terminal.

9. An application server of a system for accessing a service in an IP network having an IMS architecture from a user terminal logged onto said network;
characterized in that said server is an IPTV server and includes means activated on reception of a service access request sent by said terminal for:
determining information about said user's subscription to said list and information about the reception capacity necessary for said at least one channel;
verifying the compatibility of said information about the reception capacity necessary for said at least one channel and a reception capacity offered by said terminal;
selecting at least one channel from said list as a function of said compatibility verification;
sending said user terminal a response to said request containing information about reception of said at least one selected channel.

10. An access terminal for accessing a service in an IP network having an IMS architecture;
characterized in that it includes:
means for sending an IPTV service access request to a television over IP application server of said IMS architecture network, a user of said terminal subscribing to a list of at least one television channel of said service, and said access request including information about the reception capacity offered by said terminal;
means for processing a response to said request sent by said application server and containing at least information about reception of at least one channel selected in said list by said application server; and
means for receiving a stream corresponding to said at least one selected channel.

11. A method of accessing a service in an IP network having an IMS architecture from a user terminal logged onto said network;
characterized in that said service is an IPTV service, said user subscribing to a list of at least one television channel of said service; and in that
said method includes:
a step of receiving a service access request sent by said terminal;
a step of determining information about said user's subscription to said list and information about the capacity necessary to receive said at least one channel;
a step of verifying the compatibility of said information about the reception capacity necessary for said at least one channel and a reception capacity offered by said terminal;
a step of selecting at least one channel from said list as a function of said compatibility verification; and
a step of sending said user terminal a response to said request containing information about reception of at least one selected channel.

12. A computer program including program code instructions for executing the steps of the service access method according to claim 11.

13. A new server according to claim 9, further including means for determining a session identifier contained in said access request sent by said terminal and means for verifying whether said session identifier corresponds to a session already in progress with said terminal.
